(19) United States
(12) Patent Application Publication
(10) Pub. No.: US 2010/0042431 A1
(43) Pub. Date: Feb. 18, 2010

(54) Impact Intelligence Oncology Management

(75) Inventors: Joe O'Connor, Lincoln, MA (US); Janis Diring Khan, Bloomfield, CT (US); Ruby K. Woo, Lexington, MA (US)

Correspondence Address: FULBRIGHT & JAWORSKI L.L.P., 600 CONGRESS AVE., SUITE 2400, AUSTIN, TX, 78701, US

(73) Assignee: INGENIX, INC.

(21) Appl. No.: 12/541,776

(22) Filed: Aug. 14, 2009

Related U.S. Application Data
(60) Provisional application No. 61/089,405, filed on Aug. 15, 2008.

(51) Int. Cl. G06Q 10/00; G06Q 50/00

(52) U.S. Cl. 705/2

(57) ABSTRACT

A system and methods for evaluating quality and cost efficiency of a healthcare service to a patient are presented. In one embodiment, the system may include a merged database comprising administrative data and clinical data, a cost-of-care efficiency engine coupled to the merged database, the cost efficiency engine configured to analyze the merged clinical data and administrative data to determine a measurement of cost efficiency, a quality engine coupled to the merged database, the quality engine configured to analyze the merged clinical data and administrative data to determine a compliance value, wherein the compliance value indicates a level of compliance with a clinical guideline, and a reporting application coupled to the cost efficiency engine and the quality engine, the reporting application configured to generate a report representing at least one of the measurement of cost efficiency and the compliance value.

### CROSS-REFERENCE TO RELATED APPLICATIONS

This application claims priority to U.S. Provisional Application No. 61/089,405 filed Aug. 15, 2008, the entire contents of which is specifically incorporated herein by reference without disclaimer.

### BACKGROUND OF THE INVENTION

1. Field of the Invention

The present invention relates generally to the fields of medical and network management. More particularly, it concerns methods and systems for evaluating the quality and cost efficiency of healthcare services.

2. Description of Related Art

A. Quality and Cost of Healthcare

Quality healthcare can be defined by the extent to which patients get the care they need in a manner that most effectively protects or restores their health. This means having timely access to care, getting treatment that medical evidence has found to be effective and getting appropriate preventive care. Choosing a high-quality health plan and a qualified physician plays a significant role in determining whether patients will get high-quality care. Measuring and reporting on healthcare quality is extremely important, because it gives consumers and employers the ability to make informed choices and pursue the best available care. Still, healthcare quality assessment is about more than just informing buyers and consumers about their options. It's also about giving feedback to health plans, medical groups, and physicians that they can use to address quality issues and improve quality of service and cost efficiency over time.

Cost-effectiveness analysis is a form of economic analysis that compares the relative expenditures (costs) and outcomes (effects) of two or more courses of action. Cost-effective analysis is important for healthcare providers to understand how much to charge for the services and for consumers and buyers to understand how much to pay for the services. Cost effectiveness in healthcare may involve measurement of the extent to which an intervention or a service achieves health improvements per unit of cost. This can be measured in terms of various outcomes such as cases of disease prevented, years of life saved, or quality-adjusted life years saved.

In today's healthcare market, the needs for evaluating quality and cost efficiency of healthcare providers are not satisfied in many fields of medicine due to the growing complexity in medical treatment options and outcomes.

For example, oncology is one healthcare field that may benefit from an integrated system of cost and quality assessment for improving care and the customer experience. Certain healthcare expenditure data shows that oncology costs represent 12% of overall commercial medical expenses. According to the National Institute of Health (NIH), these costs are growing at 13% annually, roughly double the overall rate of medical costs. Overall annual cancer direct medical costs in the U.S. were $78.2 billon in 2006. However, only four cancer categories (lung, breast, colorectal, and prostate) represent over 50% of total oncology costs. Certain AIS studies have suggested that over 400 new drugs, representing a significant portion of all drugs currently in development, are focused on cancer care. Nonetheless, when evaluated using a comprehensive multi-year outcomes database, concordance with clinical guideline rates vary across different types of cancer care, patients and institutions. Furthermore, a typical cancer patient is often ill-equipped to choose among doctors and hospitals because of the scarcity of information about their varying quality cancer care and compliance with national guidelines.

Differentials in quality of care also pose serious problems for healthcare systems and health insurance companies, especially in fields such as oncology that typically generate high costs. Studies suggest that significant numbers of patients miss out on cancer treatments that could prevent recurrence, prolong survival, or save lives. Such treatments may include appropriate chemotherapy (recurrence costs $30,000) or limited screening (colonoscopy costs $500-1000 while cost of colon cancer early stage is $30,000 and of colon cancer late stage is $120,000) in colon cancer, and under-treatment with radiation or under-use of anti-estrogen drug therapy in breast cancer. Additionally, over-treatment which wastes resources and money and needlessly subjects patients to the pain and risks of surgery or radiation, such as over-treatment with radical surgery (one surgery averages $12,150) or radiation (average radiation cost $57,357 for 6 weeks of treatment (Konski, 2006)) and under-use of experienced surgeons (Vickers et al., 2007) in prostate cancer, and inappropriate usage of Herceptin drug therapy in breast cancer (annual cost of treatment is $40,000) may occur. (Grady, 2007). Therefore, there remains a need for a more robust and reliable assessment of quality and cost of healthcare services.

B. Administrative Data

Administrative data is often used to evaluate the quality of healthcare. This data is typically derived from administering healthcare services, enrolling members into health insurance plans, and reimbursing for services. The primary producers of administrative data are the federal government, state governments, and private healthcare insurers. Administrative data is readily available, inexpensive to acquire, computer readable, and typically encompass large populations. Many hospital report cards and physician profiles are derived from administrative data.

Gaps in clinical information and the billing context typically compromise the ability to derive valid quality appraisals from administrative data. One example of typical administrative data is shown in Table 1 below. This particular data provides a limited view of quality of care for breast cancer patients. Currently, the type of cancer and the type of treatments are known, but only a limited view of general treatment rules can be created from typical administrative data, while questions such as “was the treatment in accordance with clinical guidelines?” still remain.

TABLE 1
Examples of Administrative Data for Evaluating
Quality of Care in Breast Cancer

| Category of Care | Rule Description |
|---|---|
| | Breast cancer patient had an annual physician visit. |
| | Breast cancer patient had an annual mammogram. |
| Care Pattern | Patient newly diagnosed with breast cancer that |
| | received radiation or chemotherapy treatment or had |
| | medical oncology or radiation oncology consultation |
| | within 90 days of the diagnostic procedure. |
| Disease | Patient with metastatic breast cancer to the bone that |
| Management | have received bisphosphonate treatment in last 12 |
| | reported months. |
| Medication | Breast cancer patient compliant with prescribed anti- |
| Adherence | estrogen for chemotherapeutic use (minimum |
| | compliance 70%). |

Similarly, general aggregate cost and occurrence data derived from administrative data as shown Table 2 below is of only limited use.

TABLE 2
Examples of Administrative Data for Evaluating Cost of Care

| Cancer Site | # of Episodes | Total Cost | Cost per Episode |
|---|---|---|---|
| Breast | 63,335 | $817,796,536 | $12,912 |
| Prostate | 14,988 | $142,036,196 | $9,477 |

The absence of clinical markers and contextual data limits the ability to create rules for assessing treatment plans against clinical guidelines. Similarly, these limits may reduce the effectiveness of cost measurement of care. There remains a vital need for methods and systems for evaluating the quality and cost of care by integrating administrative data and clinical data.

### SUMMARY OF THE INVENTION

A system for evaluating quality and cost efficiency of a healthcare service to a patient is presented. In one embodiment, the system may include a merged database comprising administrative data and clinical data, a cost-of-care efficiency engine coupled to the merged database, the cost efficiency engine configured to analyze the merged clinical data and administrative data to determine a measurement of cost efficiency, a quality engine coupled to the merged database, the quality engine configured to analyze the merged clinical data and administrative data to determine a compliance value, wherein the compliance value indicates a level of compliance with a clinical guideline, and a reporting application coupled to the cost efficiency engine and the quality engine, the reporting application configured to generate a report representing at least one of the measurement of cost efficiency and the compliance value.

In a further embodiment, the clinical data is collected by a clinical exchange system and a clinical coding system. The clinical exchange system may include fax, internet based data exchange forms, or EMR interface. In a certain embodiment, the target specialty is oncology, cardiology, or orthopedics. In one specific embodiment, the specialty is oncology. The clinical data may include histology, tumor stage, tumor cell receptor expression or disease progression. In a certain embodiment, the clinical coding system comprises a data dictionary. The data dictionary may include initial diagnosis, disease stage or treatment status. In still another embodiment, the system may further comprise a benchmark module.

A method for evaluating quality of healthcare service to a patient is also presented. In one embodiment, the method includes merging clinical data and administrative data, analyzing the merged clinical data and administrative data to determine a compliance value, wherein the compliance value indicates a level compliance of with a clinical guideline, and generating a report representing the compliance value. In a further embodiment, the clinical guideline may include a treatment guideline or medication adherence. In still another embodiment, the clinical guideline is an NCCN guideline.

A method for evaluating cost efficiency of a healthcare service to a patient is also presented. In one embodiment, this method includes merging clinical data and administrative data, analyzing the merged clinical data and administrative data to determine a measurement of cost efficiency, and generating a report representing the measurement of cost efficiency. In a further embodiment, the clinical data includes initial stage, disease stage, treatment status or prognostic indicators.

Additionally, the methods may include aggregating clinical and administrative data to provide a benchmark. In a certain embodiment, the provider is a physician, a hospital, a clinic or an emergency room. In still another embodiment, the provider is an individual or a healthcare network. The stakeholder may include a consumer, a healthcare provider, a payer or an employer.

It is contemplated that any methods or systems described herein can be implemented with respect to any other methods or systems described herein.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

Other objects, features and advantages of the present invention will become apparent from the following detailed description. It should be understood, however, that the detailed description, while indicating specific embodiments of the invention, are given by way of illustration only, since various changes and modifications within the spirit and scope of the invention will be apparent to those skilled in the art from this detailed description.

### BRIEF DESCRIPTION OF THE DRAWINGS

The following drawings form part of the present specification and are included to further demonstrate certain aspects of the present invention. The drawings do not limit the scope but simply offer examples. The present embodiments may be better understood by reference to one or more of these drawings in combination with the description of the illustrative embodiments presented herein:

FIG. 1. A flow chart representative of an exemplary system of the present invention.

FIG. 2. A certain embodiment of clinical data collection methods.

FIG. 3. Episode Units: stages of disease progression.

FIG. 4. An example of episode units of breast cancer sample patient 1.

FIG. 5. Another example of episode units of breast cancer sample patient 2.

FIG. 6. A certain embodiment of quality engine analysis of compliance with NCCN™ Drug and Biologics Compendium.

FIG. 7. An example of NCCN guideline for radiation following mastectomy in invasive breast cancer.

FIG. 8. Examples of role of IIOM system in disease management.

### DESCRIPTION OF THE ILLUSTRATIVE EMBODIMENTS

### I. DEFINITIONS

As used in this disclosure, “administrative data” or “health plan administrative data” is used according to the ordinary meaning in the art and should contain records associated with at least one or more medical procedures, prescriptions, diagnosis, medical devices, or the like.

As used in this disclosure, a “clinical exchange system” refers to a system comprising fax forms, web technologies, etc. provided to customers to facilitate the collection of clinical data from providers including physicians and facilities.

As used in this disclosure, a “clinical coding system” refers to a set of coding specifications including descriptions and formats for collecting clinical data, as well as a data dictionary.

As used in this disclosure, a “quality engine” refers to a software system comprising analytic algorithms that utilizes merged clinical and administrative data to measure whether actual healthcare delivery for patients is in concordance with a clinical guideline, e.g., NCCN (the National Comprehensive Cancer Network) guidelines.

As used in this disclosure, a “cost-of-care/efficiency engine” refers to a software system that utilizes merged clinical and administrative data to measure the costs of disease episodes, such as using the Ingenix Episode Treatment Groups(® (ETG® system).

As used in this disclosure, a “reporting application” refers to a software system used by customers to generate reports and analysis based on use of a quality/efficiency engine.

As used in this disclosure, a “benchmark” refers to aggregated results and measures of concordance/efficiency using data from multiple customers to contribute data to the aggregated database.

As used in this disclosure, a “data integration service” refers to a service provided to customers to assist in merging clinical data and administrative data.

As used in this disclosure, “data management” refers to a service provided to update and maintain client databases.

As used in this disclosure, an “application integration service” refers to a supplemental consulting service provided to clients to assist them in linking information derived from the Impact Intelligence Oncology Management solution to other client systems or applications.

As used in this disclosure, a “clinical training/consulting program” refers to a supplemental service provided to customers to establish programs in areas such as provider education, medical management, etc., based on information derived from the IIOM system.

As used in this disclosure, a “clinical guideline” can be any clinical guideline known in the art, which is also called medical guideline, clinical protocol or clinical practice guideline. It refers to a document with the aim of guiding decisions and criteria regarding diagnosis, management, and treatment in specific areas of healthcare.

Clinical guidelines may identify, summarize and evaluate the evidence and current data about prevention, diagnosis, prognosis, therapy including dosage of medications, risk/benefit and cost-effectiveness. In one embodiment, clinical guidelines may also define questions related to clinical practice and identify possible decision options and associated results. Certain guidelines may contain decision or computation algorithms discussed below. Thus, the clinical guidelines may integrate the identified decision points and respective courses of action with the clinical judgment and experience of practitioners. Many such guidelines place the treatment alternatives into classes to help providers decide which treatment to use. Additional objectives of clinical guidelines may include standardization of medical care, increased quality of care, reduction of risk, and achieving the best balance between cost and medical parameters such as effectiveness, specificity, sensitivity, resoluteness, etc.

For example, NCCN clinical guidelines, such as the NCCN Drugs and Biological Compendium™ and NCCN Clinical Practice Guidelines™ in Oncology, are defined as “systematically developed statements to assist practitioner and patient decisions about appropriate healthcare for specific clinical circumstances” (Field, 1990).

As used in this disclosure, an “episode” in healthcare means a block of one or more healthcare services received by an individual during a period of relatively continuous contact with one or more providers of service, in relation to a particular medical problem or situation.

### II. IMPACT INTELLIGENCE ONCOLOGY MANAGEMENT SYSTEM AND METHODS

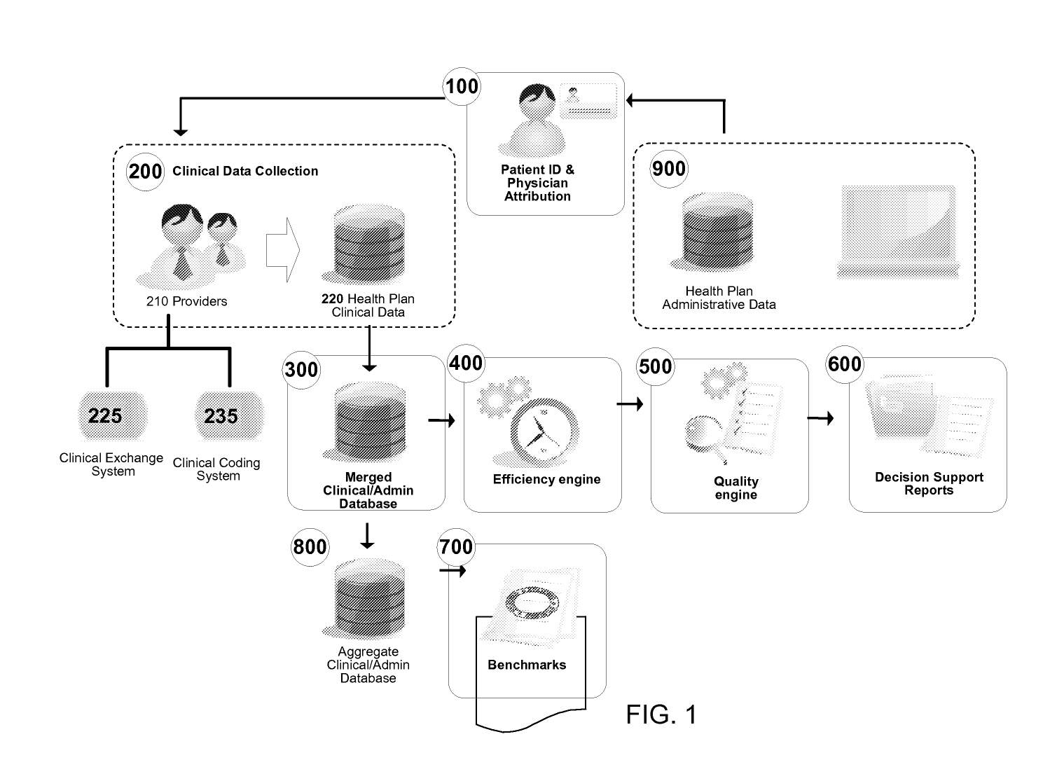

Referring to FIG. 1, there is shown a system as a specific example of an Impact Intelligence Oncology Management system in accordance with the present embodiments. In particular, this system may include a patient and provider identification module 100, a clinical data collection module 200, an integrated or merged database 300 a quality engine 500, an efficiency engine 400, a reporting application 600 and benchmarks 700.

A. Module 100: Cancer Patient Identification

The patient identification and provider attribution module 100 identifies patients or healthcare insurance plan members and their primary providers or physicians using administrative data. For example, the patient and provider identification module 100 may generate a report of cancer patients and their providers using existing administrative data. In one embodiment, patients may be identified for different cancer types, such as breast, prostate, lung, and colorectal cancers. Additionally, the report may be narrowed by cancer site, geography, etc., to allow for targeted outreach.

B. Module 200: Clinical Data Collection

After the providers have been identified for specific patients by the patient identification and provider attribution module 100, the clinical data collection module 200 may collect clinical data 220 for these patients from identified corresponding healthcare providers or physicians in healthcare network 210.

In certain embodiments, different types of clinical data may be collected, including: initial diagnosis data such as stage and disease markers and ongoing clinical assessment of the patient's status. For example, clinical data for breast cancer may include histology (i.e., ductal, lobular, adenocarcinoma), tumor stage or TNM status (defined by (T)umor size, (N)odal involvement, and (M)etastatic spread), expression status of tumor cell receptors (such as estrogen and progesterone receptors (ER/PR) or Her-2 neu receptors) and disease progression.

In certain embodiments, initial diagnosis data may include a date of initial diagnosis, site, histology, disease status (e.g., TNM status), status of disease markers such as tumor cell receptors, or grade for certain cancers.

In another embodiment, ongoing clinical assessment data may include a date of assessment and clinical status, date of death, an enrollment status in clinical trials, or a prognostic index. Clinical status may include: (i) disease free; (ii) initial adjuvant treatment ongoing; (iii) recurrence/progression—local; (iv) recurrence/progression—regional; (v) recurrence/progression—metastatic; (vi) end of life care; (vii) death due to cancer; and/or (viii) death due to other or unknown cause. Ongoing clinical assessment data in breast cancer may also include menopausal or pregnancy status.

In further embodiments, the clinical data collection module 200 may include a clinical exchange system 225 and a clinical coding system 235. The clinical coding system 235 may be a set of coding specifications including descriptions and formats for collecting clinical data, as well as a data dictionary. One example of a coding specification is a set of oncology G-codes as exemplified in Table 3. The oncology G-codes are temporary national codes for items or services requiring uniform national coding between one year's update and the next.

TABLE 3
Sample Oncology Demonstration Project G-codes
(in Numerical Order by Code)

| | |
|---|---|
| Category/G-code | Description |

Primary focus of the visit

| | |
|---|---|
| G9050 | Oncology; primary focus of visit; work-up, evaluation, or staging |
| | at the time of cancer diagnosis or recurrence (for use in a medicare- |
| | approved demonstration project) |
| G9051 | Oncology; primary focus of visit; treatment decision-making after |
| | disease is staged or restaged, discussion of treatment options, |
| | supervising/coordinating active cancer directed therapy or managing |
| | consequences of cancer directed therapy |
| G9052 | Oncology; primary focus of visit; surveillance for disease |
| | recurrence for patient who has completed definitive cancer- |
| | directed therapy and currently lacks evidence of recurrent |
| | disease; cancer directed therapy might be considered in the future |
| G9053 | Oncology; primary focus of visit; expectant management of |
| | patient with evidence of cancer for whom no cancer directed |
| | therapy is being administered or arranged at present; cancer |
| | directed therapy might be considered in the future |
| G9054 | Oncology; primary focus of visit; supervising, coordinating or |
| | managing care of patient with terminal cancer or for whom other |
| | medical illness prevents further cancer treatment; includes |
| | symptom management, end-of-life care planning, management of |
| | palliative therapies |
| G9055 | Oncology; primary focus of visit; other, unspecified service not |
| | otherwise listed |

Guideline adherence codes

| | |
|---|---|
| G9056 | Oncology; practice guidelines; management adheres to guidelines |
| G9057 | Oncology; practice guidelines; management differs from |
| | guidelines as a result of patient enrollment in an institutional |
| | review board approved clinical trial |
| G9058 | Oncology; practice guidelines; management differs from |
| | guidelines because the treating physician disagrees with guideline |
| | recommendations |
| G9059 | Oncology; practice guidelines; management differs from |
| | guidelines because the patient, after being offered treatment |
| | consistent with guidelines, has opted for alternative treatment or |
| | management, including no treatment |
| G9060 | Oncology; practice guidelines; management differs from |
| | guidelines for reason(s) associated with patient comorbid illness |
| | or performance status not factored into guidelines |
| G9061 | Oncology; practice guidelines; patient's condition not addressed by |
| | available guidelines |
| G9062 | Oncology; practice guidelines; management differs from |
| | guidelines for other reason(s) not listed |

In one embodiment, the collected clinical data may be stored or deposited as data dictionaries comprised in the clinical coding system 235. A data dictionary may be used to identify the clinical information to be collected. IIOM's data dictionary, built in collaboration with clinical guidelines, may be included as a component of the quality and efficiency analysis. Sample data dictionaries representing initial diagnosis file or ongoing treatment file for breast cancer are shown in Tables 4-5.

TABLE 4
Sample Data Dictionary: Initial Diagnosis File for Breast Cancer

| Data Item | Refinements |
|---|---|
| Tumor Status | 1. TX |
| | 2. T0 |
| | 3. Tis |
| | 4. Tis (DCIS) |
| | 5. Tis (LCIS) |
| | 6. Tis (Paget's) |
| | 7. T1mic |
| | 8. T1a |
| | 9. T1b |
| | 10. T1c |
| | 11. T2 |
| | 12. T3 |
| | 13. T4a |
| | 14. T4b |
| | 15. T4c |
| | 16. T4d |
| Nodal Status | 1. NX |
| | 2. N0 |
| | 3. N1 |
| | 4. N1mi |
| | 5. N1a |
| | 6. N1b |
| | 7. N1c |
| | 8. N2a |
| | 9. N2b |
| | 10. N3a |
| | 11. N3b |
| | 12. N3c |
| Metastatic Status | 1. MX |
| | 2. M0 |
| | 3. M1 |
| Histological | 1. Unknown |
| Type | 2. In situ - Intraductal |
| | 3. In situ - Paget's disease and intraductal |
| | 4. In situ - Other or not otherwise specified |
| | (NOS) |
| | 5. Invasive - Ductal and/or Lobular, Mixed, |
| | Metaphasic |
| | 6. Invasive - Tubular or colloid |
| | 7. Invasive - Paget's disease and infiltrating |
| | 8. Invasive - All Other (includes NOS) |
| HER2 Status | 1. Over Expressed (IHC 3+ or FISH > 2.0) |
| | 2. Under Expressed |
| | 3. Unknown |
| Estrogen Receptor (ER) | 1. Positive |
| Status | 2. Negative |
| | 3. Unknown |
| Progesterone Receptor | 1. Positive |
| (PR) Status | 2. Negative |
| | 3. Unknown |

TABLE 5
Sample date Dictionary: Interim treatment Status File for Breast Cancer

| Data Item | Refinements |
|---|---|
| Date of most current physician | MMDDYYYY |
| assessment | |
| Clinical Status | Disease free |
| | Initial adjuvant treatment ongoing |
| | Recurrent/Progression-Local, |
| | Regional, or Metastatic |
| | End of life care |
| | Death-from cancer, from other cause |
| Date of Death | MMDDYYY |
| Reproductive Status | Pregnant |
| | Ovum stimulation |
| | Premenopausal |
| | Postmenopausal |
| | Unknown |
| Performance Status (ECOG) | Fully active |
| | Ambulatory, but restricted |
| | Ambulatory, self care only |
| | Confided, limited self care |
| | Completely disabled |

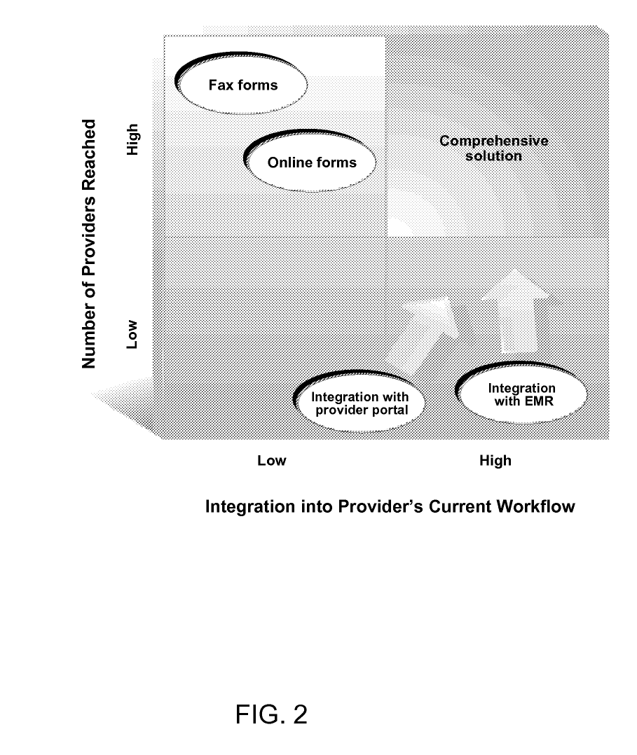

In a further embodiment, the clinical data collection module 200 may create a “comprehensive” solution to reach the targeted providers 210 for requesting clinical data 220 as illustrated in FIG. 2. The clinical data collection module 200 may collect clinical data from providers 210 through the clinical exchange system 225, which may include fax forms and online submission forms. Additional methods may be developed to meet the needs of certain provider networks or patient programs and integrated into this IIOM system. For example, integration into provider's current workflow may improve the efficiency of data collection, by using a more highly integrated tools like EMR (electronic medical records) as they are more widely adopted.

In a further embodiment of the clinical data collection module 200, financial and non-financial incentives can be used with network physicians to increase participation in data sharing and facilitate the collection of clinical data as show below in Table 6.

TABLE 6
Positive Incentives in the Collection of Clinical Data

| Incentive | |
|---|---|
| Category | Description |
| Information-based | Participating physicians receive reports on their |
| | performance relative to other network physicians, |
| | including individual and aggregate performance data |
| Administrative | Participating physicians do not need to provide |
| | notification for selected procedures such as radiology |
| Recognition- | Participating physicians are eligible to participate in |
| based | a health plan's elite designation program |
| Financial | Participating physicians receive set payment on a per |
| | element or per member basis for providing clinical |
| | data |
| Contractual | Participating providers are obligated through their |
| | contracts with the health plan to share specified |
| | clinical data |

C. Module 300: Integrated Clinical and Administrative Database

Following clinical data collection, the clinical data 220 and administrative data 900 may be merged or deposited into a merged database 300 to store the administrative and clinical data. Data in the merged database 300 may be further processed by the cost-of-care/efficiency engine 400 and the quality engine 500. In one embodiment, the merged clinical and administrative data may facilitate a comparison of an actual treatment plan to a clinical guild line. In this embodiment, cost of care may be evaluated using episode of care units, risk assessment technologies and evidence-based rules regarding cost-effectiveness. Furthermore, benchmarks may be developed from the national database across different health plans.

D. Module 400: Cost-of-Care/Efficiency Engine

In one embodiment, the cost-of-care efficiency engine 400 may analyze clinical/administrative data stored in the merged database 300 to measure cost of care at a high level of granularity. Clinical data, including initial stage and ongoing treatment status, may support the computation of risk adjusted costs. Both initial diagnosis and treatment status may impact the choice of treatment and associated costs. Other factors may include tumor cell receptors, other prognostic indicators (e.g., menopausal status), etc.

In certain aspects, the cost-of-care/efficiency engine 400 may generate episode units and analyze cost. For example, the cost efficiency engine 400 may process claim data through a grouping method such as the ETG (episode treatment group) grouper. Episode Risk Groups (ERGs) have been developed to offer a more accurate health risk assessment tool with greater predictive power. Like many existing models, ERGs use demographic variables and diagnoses to predict health risk. One differentiator of ERGs over existing systems is the use of “episodes of care” as markers of risk. By leveraging Episode Treatment Groups (ETGs), the ERG model focuses on the key information describing a patient's underlying medical condition, rather than the individual services provided during the treatment of that condition. In this example, each claim service line may be assigned to an episode of care based on diagnosis, procedure codes, and proximity.

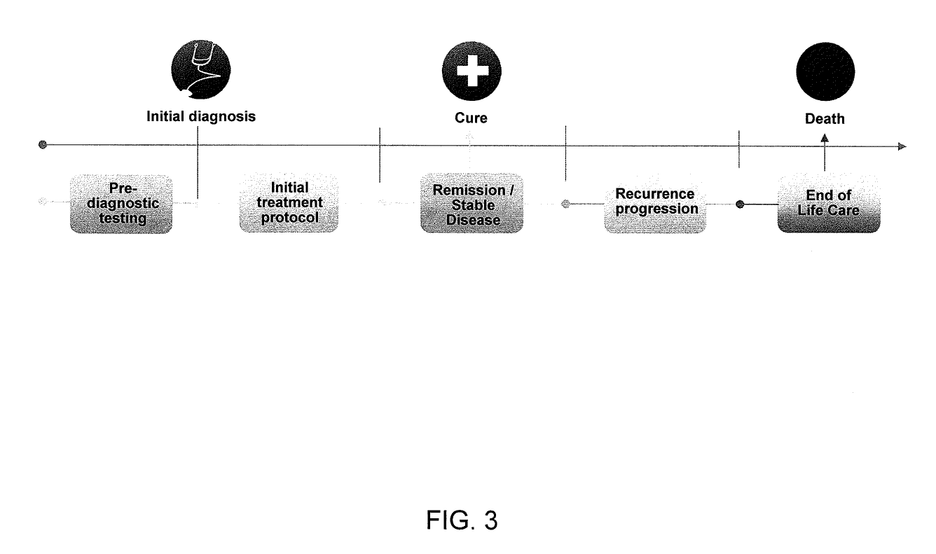

In a further embodiment, ETGs may be split into episode units. Some examples of episode units are shown in FIG. 3. These episode units may include: (1) pre-diagnostic testing; (2) initial treatment; (3) remission or stable disease; (4) progression or recurrence; (5) end of life care. These episode units reflect stage of disease progression and also include clinical markers such as stage, tumor cell receptors and reproductive status.

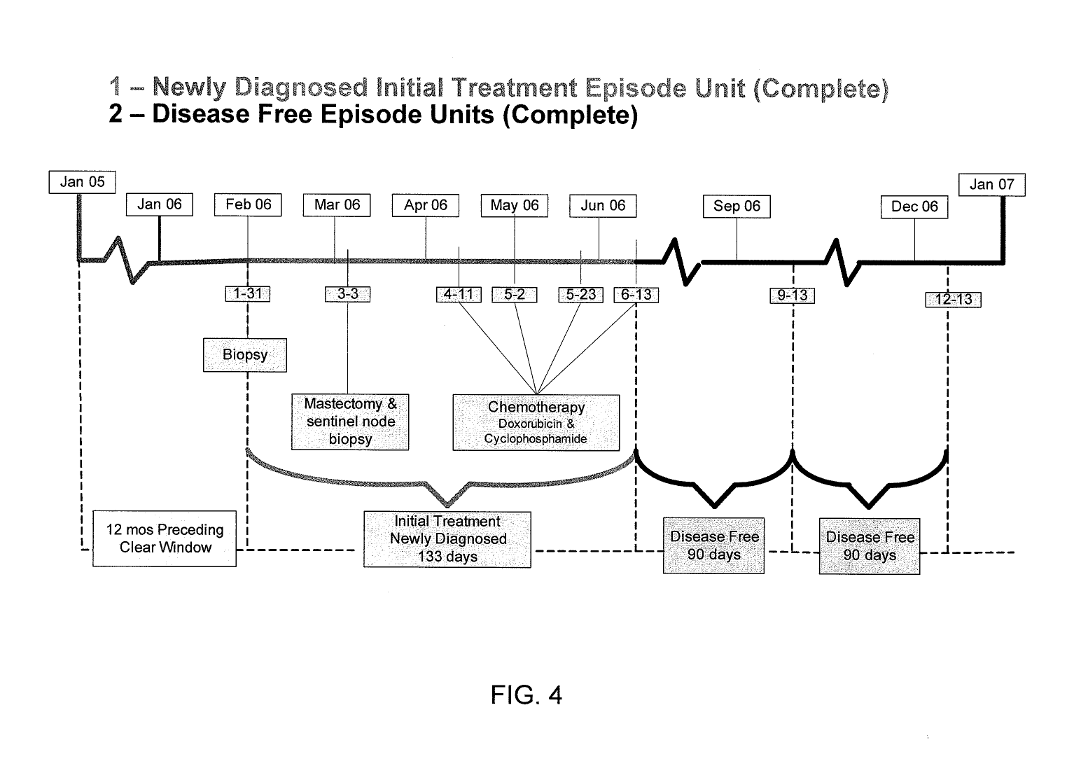

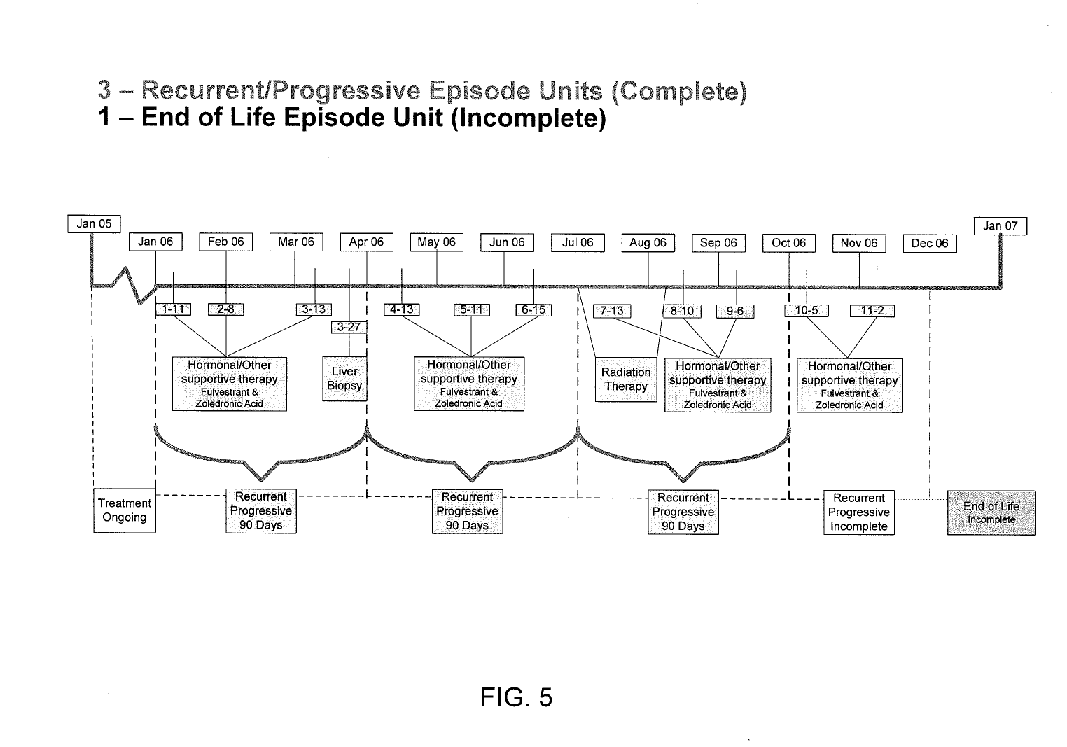

The cost efficiency engine 400 may also assign risk weights to episode units to account for patient characteristics that influence cost, such as age and gender, co-morbidities, and clinical markers (e.g., stage group, histology, tumor cell receptors, and other characteristics). Characteristics of two Sample breast cancer patients are shown in Tables 7-8 below and their episode units are represented in FIGS. 4-5, respectively.

TABLE 7
Breast Cancer Sample Patient 1

| Incentive Category | Description |
|---|---|
| Age | 57 years old |
| Gender | Female |
| Cancer Site | Breast |
| Histology | Malignant Adenocarcinoma (excludes ductal |
| | carcinoma in situ) |
| Stage Group | Stage IIA |
| Tumor Cell | ER/PR+ |
| Receptors | HER2− |
| Co-morbidities | Joint degeneration, localized - back |
| | Irritable bowel syndrome |
| | Acute Bronchitis |
| | Hereditary and degenerative diseases of the central |
| | nervous system |
| | Malignant skin neoplasm, major |

TABLE 8
Breast Cancer Sample Patient 2

| Incentive Category | Description |
|---|---|
| Age | 80 years old |
| Gender | Female |
| Cancer Site | Breast |
| Histology | Malignant Adenocarcinoma (excludes ductal |
| | carcinoma in situ) |
| Stage Group | Stage IV |
| Tumor Cell | Unknown |
| Receptors | |
| Co-morbidities | Liver Metastasis |
| | Bone Metastasis |
| | Joint degeneration, localized - thigh, hip & pelvis |
| | Closed fracture or dislocation - thigh, hip & pelvis |
| | Glaucoma |
| | Macular degeneration |

In a further embodiment, the cost-of-care/efficiency engine 400 may perform cost of care measurements using a combination of administrative data and clinical data. Administrative data alone may provide a limited view of cost of care, such as allowing analysis across all cancers by site exemplified in Table 9. However, when clinical data is integrated with the administrative data, the cost efficiency engine 400 may measure costs of care at a much more granular level than that with administrative data alone. For example, the cost efficiency engine 400 may perform cost analysis on each step of disease progression or episode unit shown in FIG. 3. The information in Table 10, shows one example of the types of cost efficiency analysis the cost efficiency engine 400 may perform. These measurements include the number of episodes, the total cost, and cost per episode corresponding to specific stage and treatment status. This level of analysis is accomplished through the incorporation of clinical data into the efficiency engine 400.

As described above, cost of care analysis using the cost efficiency engine 400 can incorporate multiple clinical concepts or data, including: initial diagnostic status, initial treatment, remission, recurrence/progression, and end of life care. Clinical concepts or data, in combination with administrative data, may be used to adjust expected costs for a particular patient group. In a further embodiment, the cost efficiency engine 400 may roll up actual and expected costs may be rolled up into usable reports for managing physicians, health planning, or other grouping.

TABLE 9
Cost of Care Measurement with Administrative Data Only

| Cancer | No. of | Pct Total | | Pct Total | Cost per |
|---|---|---|---|---|---|
| Site | Episodes | Episodes | Total Cost | Episodes | Episode |
| Breast | 63,335 | 100% | $817,796,536 | 100% | $12,912 |
| w/ | 17,999 | 28% | $687,200,608 | 84% | $38,180 |
| active | | | | | |
| mgmt | | | | | |
| w/o | 45,336 | 72% | $130,595,928 | 16% | $2,881 |
| active | | | | | |
| mgmt | | | | | |

TABLE 10
Cost of Care Measurement with Clinical Data and Administrative Data

| | Stage | | | | |
|---|---|---|---|---|---|
| | Group at | | # of | | Cost per |
| Cancer | Initial | Treatment | Episode | | Episode |
| Site | Diagnosis | Status | Units | Total Cost | Unit |
| Breast | IIA | Initial | 167 | $3,458,503 | $20,710 |
| | | Treatment | | | |
| Breast | IIIA | Initial | 12 | $245,306 | $20,442 |
| | | Treatment | | | |
| Breast | IV | Initial | 26 | $763,047 | $29,348 |
| | | Treatment | | | |
| Breast | Any | Progression | 1,941 | $32,232,246 | $16,606 |
| | | or Recurrent | | | |
| Breast | Any | Remission or | 16,587 | $13,933,080 | $840 |
| | | Cure | | | |
| Breast | Any | End of Life | 21 | $31,857 | $1,517 |

E. Module 500: Quality Engine

A quality engine 500 may further process the data stored in the merged database 300. The quality engine 500 may be implemented as software system comprising analytic software modules configured to measure whether healthcare services delivered to patients are in compliance with a clinical guideline. In one embodiment, administrative data may be used to create general treatment rules, such as whether the patient had a mammogram or whether the person is diagnosed with certain cancer. The quality engine 500 may then assess whether a particular patient's treatment was in compliance with the treatment rules by evaluating the clinical data against a the treatment rules.

In a further embodiment, the quality engine 500 may determine whether the patient received the recommended medicine or treatment for the particular disease that he or she has. For example, the quality engine 500 may measure compliance with NCCN™ Drug and Biologics Compendium, concordance with Selected NCCN™ Treatment Guidelines or other quality engine processes, such as Patient Co-morbidity list or Patient Adherence to Prescribed Drugs (Chronic Drug List).

The NCCN Drugs & Biologics Compendium™ is the latest in a series of evaluative information products intended to optimize the clinical decision-making process with a view toward improving the care available to patients. The Compendium contains authoritative, scientifically derived information designed to support decision-making about the appropriate use of drug and biologic therapy in patients with cancer. The Compendium lists appropriate uses of agents as defined in and derived from the NCCN Clinical Practice Guidelines in Oncology™. As such, the uses listed in the Compendium are based upon the evaluation of evidence from scientific literature, integrated with expert judgment in a consensus-driven process. The Compendium is indexed by drug and biological agent whereas the NCCN Clinical Practice Guidelines in Oncology™ are indexed by disease. The Compendium identifies the pharmacologic characteristics of each drug or biological and includes information on route of administration, as well as the recommended uses in specific diseases. The indicated uses are categorized in a systematic approach that describes the type of evidence available for and the degree of consensus underlying each recommendation.

NCCN Drug and Biologics Compendium has a list of anti-neoplastic therapeutic drug classes that are appropriate for treatment of various cancer diagnosis, including: 29 for breast cancer, 13 for prostate cancer, 8 for colorectal, and 19 for lung cancer, and for 30+ other cancers. In one embodiment, the quality engine 500 may analyze pharmacy claim data for certain types of cancer against the Compendium to measure compliance according to diagnosis code. The algorithm used in quality engine 500 also accounts for co-morbidities.

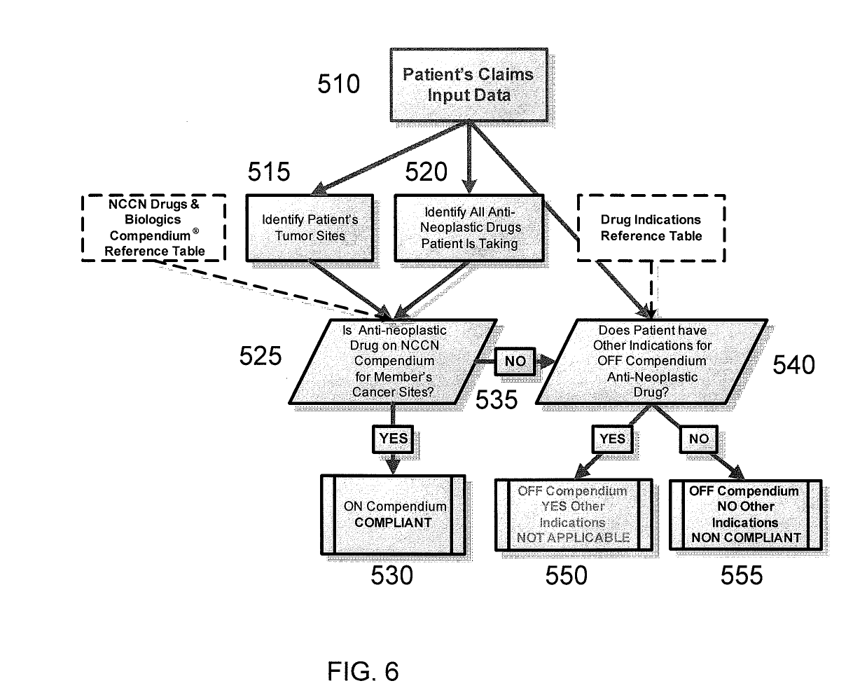

In exemplary embodiments as shown in FIG. 6, the quality engine 500 may analyze compliance with NCCN™ Drug and Biologics Compendium in post adjudication of medical and managed of pharmacy claims. The IIOM system may identify patients with site specific cancer at step 515, and compare against anti-neoplastic drugs received by the patients at step 520 by processing medical and pharmacy claim data. The quality engine 500 may further determine whether anti-neoplastic drugs received by patients are on NCCN™ Drug Compendium by cancer site at step 525. In one embodiment, if the drug is on the Compendium, the quality engine 500 may determine whether the drugs received by patients with a specific cancer site was in compliance with the Compendium at step 530.

If the drug is not compliant with the Compendium 535, the quality engine 500 may analyze administrative data to identify co-morbidities 540 based on a condition class and various diagnosis code sets. If the use of the drug is not compliant, the quality engine 500 may identify co-morbid conditions that justify use of the drug. If the use is non-compliant and there are no co-morbidities to justify the use, then the use is off-compendium. The analysis in Table 11 shows that a considerable portion of drugs taken by cancer patients are not on the NCCN list and are associated with expensive costs, which may be preventable by applying the quality engine 500, based on analysis of the Integrated Healthcare Information Services (IHCIS) Database of 22.6 million patients (95, 255 with breast cancer, 24, 989 with colon cancer, 8,090 with rectal cancer).

TABLE 11
Analysis of IHCIS Database on Anti-Neoplastic Drugs

| | | | | % taking | |
|---|---|---|---|---|---|
| | | # taking | | Non- | |
| Study | | Anti-neoplastic | Anti-neoplastic | NCCN | Non-NCCN |
| Population | Description | Rx | Spend | Rx | Drug Spend |
| 1 | New Cases - | 10,420 | $57,170,876 | 3% | $988,351 |
| | No indication | | | | |
| | of metastatic | | | | |
| | spread | | | | |
| 2 | Ongoing | 23,565 | $76,322,939 | 3% | $3,965,105 |
| | cases without | | | | |
| | progression | | | | |
| 3 | Ongoing | 2,112 | $54,641,451 | 12% | $1,958,732 |
| | cases with | | | | |
| | progression | | | | |
| | (no | | | | |
| | indication of | | | | |
| | additional | | | | |
| | primary | | | | |
| | tumors) | | | | |
| 4 | Ongoing | 8,453 | $193,066,257 | 28% | $25,546,455 |
| | cases with | | | | |
| | indication of | | | | |
| | additional | | | | |
| | primary | | | | |
| | tumors (w/ or | | | | |
| | w/o | | | | |
| | progression) | | | | |
| | Total for | 44,640 | $381,201,523 | 9% | $32,458,643 |
| | Breast, | | | | |
| | Colon and | | | | |
| | Rectal | | | | |
| | Cancers | | | | |

In certain embodiments, the quality engine 500 may also analyze concordance with selected NCCN™ Treatment guidelines. In oncology, NCCN treatment guidelines are widely accepted, endorsed and used by academic and community cancer centers, as well as practicing oncologists. These guidelines have been developed to provide recommendations for managing the major symptoms experienced by patients with cancer and a set of pathways detailing the major early diagnostic steps for breast, lung, colorectal, and prostate cancer (available through world wide web at nccn.org). Each guideline may include an algorithm or decision pathway outlining care management, a manuscript discussing important issues related to the algorithm, and references providing data on which recommendations are based.

Recommended treatments according to NCCN guidelines vary based on the patient's clinical parameters, including: histology (i.e., ductal, lobular, adenocarcinoma), tumor stage or TNM status as described below, tumor cell receptors (varies by cancer, such as estrogen and progesterone receptors (ER/PR) or Her-2 neu receptors for breast cancer), disease progression. Tumor stage is defined by (T)umor size, (N)odal involvement, and (M)etastatic spread. Tumor stage group is a summary of TNM status, which can be used for reporting purposes (e.g., Stage I, Stage II, Stage III, Stage IV). Multiple treatment options may be accepted for a specific tumor stage and other clinical status markers.

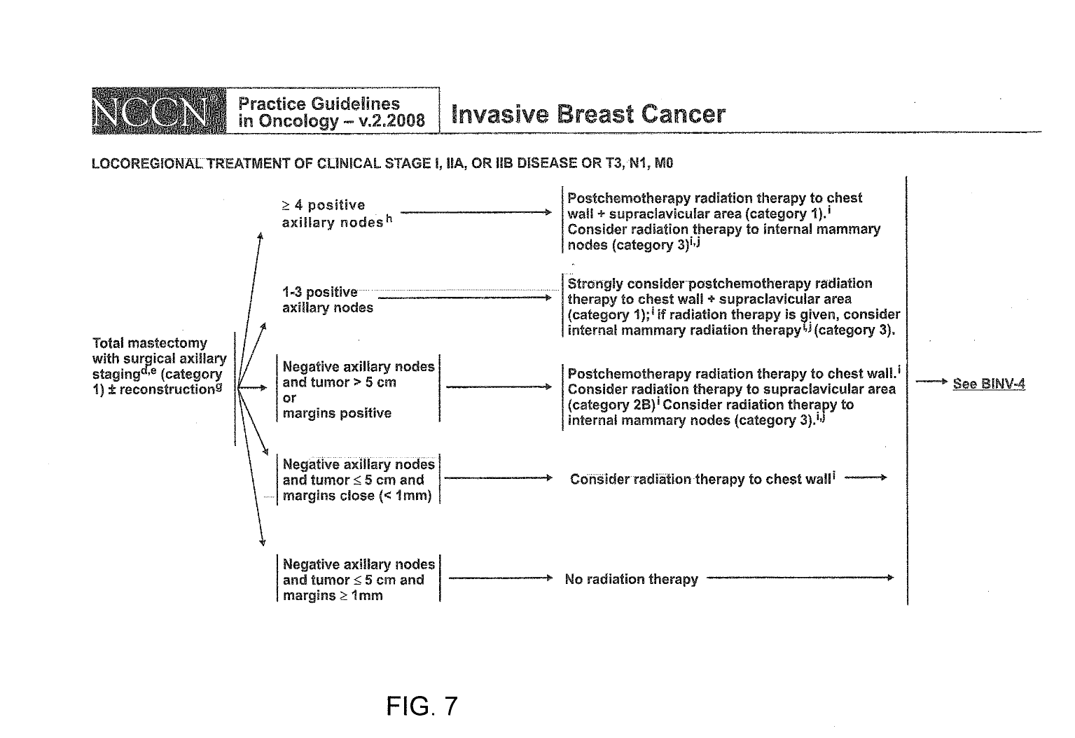

For example, certain NCCN guidelines regarding radiation following mastectomy in invasive breast cancer are presented in FIG. 7 and illustrated in Table 12. By analysis of a combination of clinical data and administrative data, the quality engine 500 may provide a more robust view of treatment protocols and their compliance with clinical guidelines. As shown in Table 13, according to administrative data alone, type of cancer and type of treatment could be known. Nonetheless, only general treatment rules can be created by this limited information—such as “did the patient see a specialist?” “Did a breast cancer patient have an annual physician visit and annual mammogram?” Absence of clinical markers prevents ability to create rules assessing treatment against clinical guidelines. Helpful clinical markers may include: histology, TNM stage, tumor cell receptors, and disease progression as presented in IIOM data, which enable creation of more specific treatment rules to compare with clinical guidelines.

TABLE 12
NCCN guidelines on radiation following mastectomy

| Patient | | | Strength of |
|---|---|---|---|
| Characteristic | Treatment | Guideline | Evidence* |
| 4+ nodes involved | Chest wall | Yes | Category 1 |
| (N2/N3) | Supraclavicular area | Yes | Category 1 |
| | Internal lymph nodes | Possible | Category 3 |
| | next to breast bone | | |
| 1-3 nodes involved | Chest wall | Yes | Category 1 |
| (N1) | Supraclavicular area | Yes | Category 1 |
| | Internal lymph nodes | Possible | Category 3 |
| | next to breast bone | | |
| 0 lymph nodes | Chest wall | Yes | |
| involved and tumor | Supraclavicular area | Possible | Category 2B |
| size is >5 cm OR | Internal lymph nodes | Possible | Category 3 |
| positive margins | next to breast bone | | |
| (T3/T4, N0) | | | |
| Tumor size is <5 cm | Chest wall | Possible | |
| and 0 nodes | Supraclavicular area | No | |
| involved (T1/T2, | Internal lymph nodes | No | |
| N0) | next to breast bone | | |

TABLE 13
Quality Measures with Integrated Clinical Data and Administrative Data

| Category of Care | Administrative Data Only | IIOM Data |
|---|---|---|
| Care Pattern | Breast cancer patient had an | Breast cancer patient |
| | annual physician visit and | receiving hormone therapy |
| | annual mammogram | not recommended by |
| | Within 90 days of the | NCCN treatment guidelines |
| | diagnostic procedure, breast | Breast cancer patient |
| | cancer patient: | receiving chemotherapy not |
| | 1) Received radiation or | recommended by NCCN |
| | chemotherapy treatment, or | treatment guidelines |
| | 2) Had medical oncology or | |
| | radiation oncology consultation | |
| Disease Management | Breast cancer patient with | Patient with invasive breast |
| | metastatic breast cancer to the | cancer who is receiving |
| | bone that has received | hormone therapy/ |
| | bisphosphonate treatment in last 12 | chemotherapy/radiation |
| | reported months | therapy as recommended by |
| | | NCCN guidelines |
| Drug Use | Breast cancer patient compliant | Patient taking Herceptin |
| | with prescribed | without evidence of over- |
| | anti-estrogen for | expression of HER2 tumor |
| | chemotherapeutic use | marker |
| | (minimum compliance 70%) | |
| | Patient receiving anti-neoplastic | |
| | medication listed on the NCCN | |
| | Drug Compendium | |

F. Module 600: Decision Support Report

In one embodiment, the reporting application 600 may generate customizable or standardized reports. For example, the reporting application 600 may generate medical management reports. The medical management reports may provide information regarding collected clinical data, as well as comparisons between the clinical data and corresponding administrative data. These quality reports may have improved clinical relevance relative to administrative data only as exemplified in Table 14. Moreover, compared with administrative data alone, which provides a limited of view of cost of care by only allowing analysis all cancers by site, reporting based on both clinical data and administrative data using the IIOM system may include more granular units of analysis as shown in Table 15.

TABLE 14
An Example of Quality Measure Report

| | Total # of | | | | | | | |
|---|---|---|---|---|---|---|---|---|
| | Unique | | | | | | # of | |
| | Members | | # of | % | # of Non | % Non | Members | % Other |
| | with Unique | Total | Compliant | Compliant | compliant | Compliant | with Other | Indications |
| DCC Description | Cancer | Dollars | Members | Dollars | Members | Dollars | Indications | Dollars |
| Doxorubicin | | | Link | | Link | | Link | |
| Cyclophosphamide | | | | | | | | |
| Epirubicin | | | | | | | | |
| Gemcitabine | | | | | | | | |
| Vinorelbine | | | | | | | | |
| Paclitaxel | | | | | | | | |
| Docetaxel | | | | | | | | |
| Capecitabine | | | | | | | | |
| Gemcitabine | | | | | | | | |
| . . . | | | | | | | | |
| TOTAL | | | | | | | | |

TABLE 15
Strategic Analytics and Management (IIOM) Oncology Enterprise Summary of Costs
Major Type of Service Cost
ETG Episode Units by Disease Progression, Initial Stage Group, and Tumor Cell Receptor Status

| Malignant | | | | | Pct | | | | | | |
|---|---|---|---|---|---|---|---|---|---|---|---|
| Neoplasm Of | | | | Total | Total | Average Cost Per Episode Unit | | | | | |
| Breast | | | No. | Breast | Breast | In- | Out- | | | | |
| Episode | ER/PR | Her-2 | Episode | Cancer | Cancer | patient | patient | | | | |
| Families | Status | Status | Units | Cost | Cost | Facility | Facility | Professional | Ancillary | Pharmacy | Total |
| Initial | − | − | | | | | | | | | |
| Treatment - | | | | | | | | | | | |
| Stage I | | | | | | | | | | | |
| Initial | + | − | | | | | | | | | |
| Treatment - | | | | | | | | | | | |
| Stage I | | | | | | | | | | | |
| Initial | + | + | | | | | | | | | |
| Treatment - | | | | | | | | | | | |
| Stage I | | | | | | | | | | | |
| Initial | − | + | | | | | | | | | |
| Treatment - | | | | | | | | | | | |
| Stage II | | | | | | | | | | | |
| Initial | + | − | | | | | | | | | |
| Treatment - | | | | | | | | | | | |
| Stage II | | | | | | | | | | | |
| Initial | + | + | | | | | | | | | |
| Treatment - | | | | | | | | | | | |
| Stage III | | | | | | | | | | | |
| Initial | − | + | | | | | | | | | |
| Treatment - | | | | | | | | | | | |
| Stage IV | | | | | | | | | | | |
| Remission | + | + | | | | | | | | | |
| Remission | − | − | | | | | | | | | |
| Progression/Recurrence | − | − | | | | | | | | | |
| Progression/Recurrence | − | + | | | | | | | | | |
| Progression/Recurrence | + | − | | | | | | | | | |
| Progression/Recurrence | + | + | | | | | | | | | |
| End of Life | NA | NA | | | | | | | | | |
| Care | | | | | | | | | | | |

G. Module 700: Benchmarks

In certain embodiments, clinical data and associated administrative data may be gathered into an aggregated clinical/administrative database 800 to provide benchmarks 700 to enable comparison between individual data from certain payers or providers and national data, therefore comparing individual provider's performance against peer's nationwide.

In certain aspects, benchmarks 700 are aggregated results and measures of concordance/efficiency using data from multiple customers to contribute data to the aggregated database and could be used as reference for evaluating quality/cost efficiency of healthcare services at various levels, such as at the plan level, at the physician level, by cancer type, by region, or by other relevant business dimensions. Benchmarking could guide several initiatives, including: building outreach programs to providers, incentivizing providers to share clinical data, or assessing performance against certain standards, such as national or regional standards.

H. Role of IIOM System in Disease Management

Analysis of combined database through these analytic engines drive provider and member-specific results. Applications of results include, but are not limited to, premium designation programs, medical management initiative, centers for excellence and provider referrals, healthcare coordination and delivery, provider profiling and education, clinical trial and outcome study provider/patient identification, care and case management programs, medical management programs and information sharing programs, guideline concordance and cost of care analysis including evaluation of drug therapies and treatment gaps, consumer activation, provider activation, employer reporting and analysis and so on.

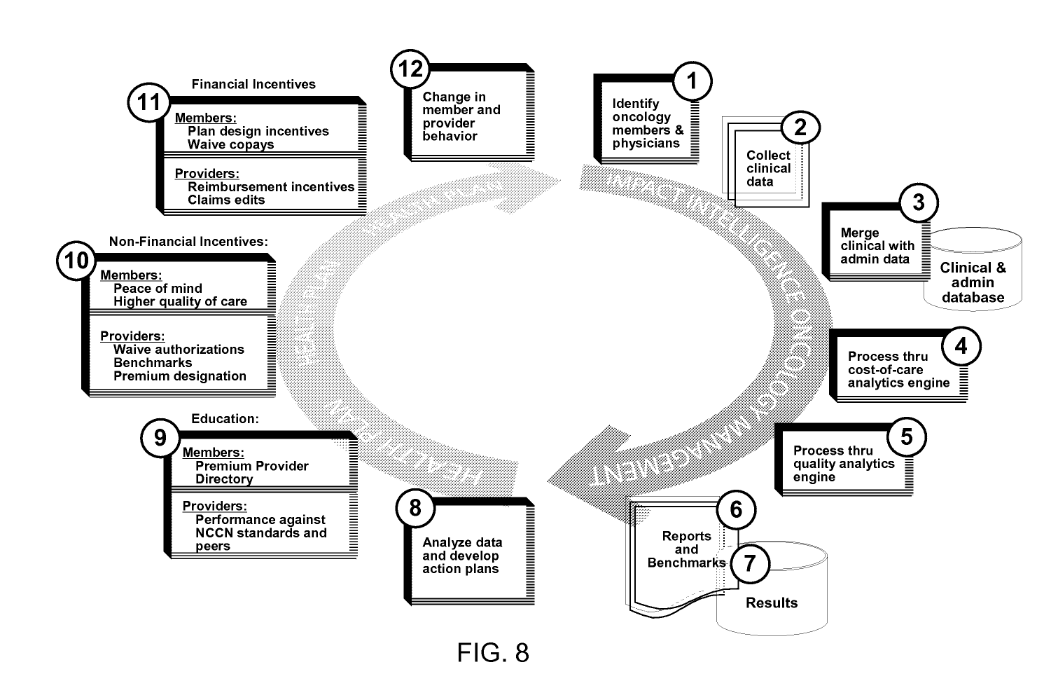

Embodiments of the present invention can provide a number of advantages. For example, the ability to collect and integrate clinical data with administrative data facilitates improvements in the care received by patients diagnosed with cancer as well as other diseases and also supports a more valid assessment of the cost and quality of the care delivered by the physicians and hospitals treating these patients. Further embodiments of the invention may drive new insights about provider quality and cost-of-care in the area of several costly cancers at a level of granularity and precision that is not currently available. These insights can drive enhancements in the care delivered to oncology patients as well as other patients and the management of the individual providers and networks serving these patients. Provider measurement and education, assurance of appropriate medication usage, and assistance with member outreach and education programs can all be supported by the information and analytics made available by the present systems and/or methods. Further applications and advantages for disease management, oncology management, are shown in FIG. 8 and Table 16 below.

TABLE 16
Examples of IIOM Analysis Applied in Oncology Management

| | | Potential | |
|---|---|---|---|
| Analysis | Example | Application | Action |
| Overall quality | Compliance to quality | Setting strategy for | Target communication |
| measures | guidelines | overall oncology | to breast cancer |
| Overall efficiency | significantly lower in | management | oncologists to promote |
| measures | breast cancer than | program | NCCN guidelines |
| NCCN drug | other cancer sites | Prioritization of | Launch colonoscopy |
| compendium | Stage IV colon cancer | opportunities for | awareness program for |
| compliance | rates and costs higher | improvement | members: health fair |
| | than expected | | promotion, waived co- |
| | 8% of oncology drug | | pays, etc. |
| | spend is not on NCCN | | Pend Non-NCCN |
| | drug compendium | | claims for manual |
| | | | review |
| Provider level | Provider A follows | Network tiering | Designate providers on |
| quality measures | NCCN guidelines 80% | Prioritization of | Quality and Efficiency |
| Provider level | of the time, Provider B | provider outreach | measures |
| efficiency | 40% of the time | | Peer to peer outreach |
| measures | Provider A's average | | to review physician |
| | cost per episode unit is | | profile report with |
| | $X, Provider B's is | | patient example |
| | $2X | | |
| Member level | Member not receiving | Member outreach | Oncology DM care |
| quality measures | radiation according to | and education | manager discusses |
| | guidelines | Provider outreach | guidelines with patient |
| | Member is taking non- | and education | Peer to peer outreach |
| | NCCN Rx | | to discuss specific |
| | | | member treatment |
| | | | protocol |

All of the systems and/or methods disclosed and claimed herein can be made and executed without undue experimentation in light of the present disclosure. While the systems and methods of this invention have been described in terms of particular embodiments, it will be apparent to those of skill in the art that variations may be applied to the systems and/or methods in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### III. REFERENCES

The following references, to the extent that they provide exemplary procedural or other details supplementary to those set forth herein, are specifically incorporated herein by reference:
Grady, New York Times, Jul. 29, 2007
Field M J, Lohr K N (eds): Clinical Practice Guidelines: Direction for a New Program. Institute of Medicine, Committee on Clinical Practice Guidelines. Washington, D.C. National Academy Press, 1990
Konski, Medical News Today, November, 2006
The Medicare Learning Network (MLN) Matters Article (Matters Number: MM4219) (http://www.cms.hhs.gov/MLNMattersArticles/downloads/MM4219.pdf)
Vickers et al., JNCI, 2007, 99(15):1171-1177.

What is claimed is:

1. A system for evaluating quality and cost efficiency of a healthcare service to a patient, comprising:
a merged database comprising administrative data and clinical data;
a cost-of-care efficiency engine coupled to the merged database, the cost efficiency engine configured to analyze the merged clinical data and administrative data to determine a measurement of cost efficiency;
a quality engine coupled to the merged database, the quality engine configured to analyze the merged clinical data and administrative data to determine a compliance value, wherein the compliance value indicates a level of compliance with a clinical guideline; and
a reporting application coupled to the cost efficiency engine and the quality engine, the reporting application configured to generate a report representing at least one of the measurement of cost efficiency and the compliance value.

2. The system of claim 1, wherein the clinical data is collected by a clinical exchange system and a clinical coding system.

3. The system of claim 2, wherein the clinical exchange system comprises fax or internet based data exchange forms.

4. The system of claim 2, wherein the specialty is oncology, cardiology, renal disease or orthopedics.

5. The system of claim 4, wherein the specialty is oncology.

6. The system of claim 5, wherein the clinical data include histology, tumor stage, tumor cell receptor expression or disease progression.

7. The system of claim 5, wherein the clinical coding system comprises a data dictionary.

8. The system of claim 7, wherein the data dictionary includes initial diagnosis, disease stage or treatment status.

9. The system of claim 1, wherein the system further comprises a benchmark module.

10. A method for evaluating quality of healthcare service to a patient, comprising:
merging clinical data and administrative data;
analyzing the merged clinical data and administrative data to determine a compliance value, wherein the compliance value indicates a level of concurrence with a clinical guideline; and
generating a report representing the compliance value.

11. The method of claim 10, wherein the clinical guideline comprises a treatment guideline or medication adherence.

12. The method of claim 11, wherein the clinical guidelines is an NCCN guideline.

13. The method of claim 10, further comprising aggregating clinical and administrative data to provide a benchmark.

14. The method of claim 10, wherein the provider is a physician, a hospital, a clinic or an emergency room.

15. The method of claim 10, wherein the provider is an individual or a healthcare network.

16. The method of claim 10, wherein the stakeholder is a consumer, a healthcare provider, a payer or an employer.

17. A method for evaluating cost efficiency of a healthcare service to a patient, comprising:
merging clinical data and administrative data;
analyzing the merged clinical data and administrative data to determine a measurement of cost efficiency; and
generating a report representing the measurement of cost efficiency.

18. The method of claim 17, wherein the clinical data include initial stage, disease stage, treatment status or prognostic indicators.

19. The method of claim 17, further comprising aggregating clinical and administrative data to provide a benchmark.

20. The method of claim 17, wherein the provider is a physician, a hospital, a clinic or an emergency room.

21. The method of claim 17, wherein the provider is an individual or a healthcare network.

22. The method of claim 17, wherein the stakeholder is a consumer, a healthcare provider, a payer or an employer.
